(19) United States
(12) Patent Application Publication
(10) Pub. No.: US 2026/0259339 A1
(43) Pub. Date: Sep. 3, 2026

(54) INDUCED SEISMIC MONITORING AUGMENTED WITH VARIOUS MULTI-TYPE SENSORS

(71) Applicant: Schlumberger Technology Corporation, Sugar Land, TX (US)

(72) Inventors: Joel Herve Le Calvez, Sugar Land, TX (US); Pierre Bettinelli, Kuala Lumpur (MY); Kamaluddin Jansen, Paris (FR)

(21) Appl. No.: 19/551,128

(22) Filed: Feb. 26, 2026

Related U.S. Application Data
(60) Provisional application No. 63/765,347, filed on Feb. 28, 2025.

(51) Int. Cl. G01V 1/28; E21B 41/00; E21B 47/00; G01V 1/30; G01V 1/34

(52) U.S. Cl. CPC G01V 1/288; E21B 41/00; E21B 47/00; G01V 1/303; G01V 1/345

(57) ABSTRACT

A method for monitoring seismic and microseismic activity in a subsurface includes positioning one or more seismic sensors at a wellsite. The method also includes positioning a plurality of non-seismic sensors at the wellsite. The method also includes measuring seismic data using the one or more seismic sensors. The method also includes measuring non-seismic data using the non-seismic sensors. The method also includes synchronizing the seismic data and the non-seismic data to produce synchronized data. The method also includes mapping seismic hypocenters in the subsurface based on the synchronized data.

### CROSS-REFERENCE TO RELATED APPLICATIONS

This application claims priority to U.S. Provisional Patent Application No. 63/765347, filed on Feb. 28, 2025 which is incorporated by reference.

### BACKGROUND

Seismic monitoring is a cornerstone of geophysical research and industrial applications, providing insights into the Earth's subsurface activities. Among the various techniques, induced seismic monitoring, passive seismic monitoring, and microseismic monitoring stand out for their unique applications and contributions to our understanding of seismic phenomena. However, what is needed is an improved system and method for augmenting induced, passive, and/or (micro-) seismic monitoring with various multi-type sensors.

### SUMMARY

A method for monitoring seismic and microseismic activity in a subsurface includes positioning one or more seismic sensors at a wellsite. The method also includes positioning a plurality of non-seismic sensors at the wellsite. The method also includes measuring seismic data using the one or more seismic sensors. The method also includes measuring non-seismic data using the non-seismic sensors. The method also includes synchronizing the seismic data and the non-seismic data to produce synchronized data. The method also includes mapping seismic hypocenters in the subsurface based on the synchronized data.

A computing system is also disclosed. The computing system includes one or more processors and a memory system. The memory system includes one or more non-transitory computer-readable media storing instructions that, when executed by at least one of the one or more processors, cause the computing system to perform operations. The operations include positioning one or more seismic sensors at a wellsite. The one or more seismic sensors are positioned in the subsurface or at a surface above a subsurface. The one or more seismic sensors are configured to measure seismic data. The one or more seismic sensors include one or more geophones, accelerometers, seismometers, or a combination thereof. The operations also include positioning a plurality of non-seismic sensors at the wellsite. The non-seismic sensors are configured to measure non-seismic data. The non-seismic sensors include different types of non-seismic sensors. The operations also include measuring the seismic data using the one or more seismic sensors. The operations also include measuring the non-seismic data using the non-seismic sensors. The operations also include synchronizing the seismic data and the non-seismic data to produce synchronized data. The operations also include mapping seismic hypocenters in the subsurface based on the synchronized data. Mapping the seismic hypocenters includes (1) interpreting the seismic hypocenters using trends and/or correlations and/or (2) determining the seismic hypocenters using triangulation. The seismic hypocenters include microseismic hypocenters. The operations also include displaying the mapped seismic hypocenters.

A non-transitory computer-readable medium is also disclosed. The medium stores instructions that, when executed by one or more processors of a computing system, cause the computing system to perform operations. The operations include positioning one or more seismic sensors at a wellsite. The one or more seismic sensors are positioned in the subsurface or at a surface above a subsurface. At least one of the one or more seismic sensors positioned in the subsurface is positioned in a monitoring well. The one or more seismic sensors are configured to measure seismic data. The one or more seismic sensors include geophones, accelerometers, and seismometers. The operations also include positioning a plurality of non-seismic sensors at the wellsite. The non-seismic sensors are configured to measure non-seismic data. The non-seismic sensors include different types of non-seismic sensors. The different types of non-seismic sensors include one or more: carbon sensors positioned in the subsurface or at the surface and configured to measure carbon data; temperature sensors positioned in the subsurface or at the surface and configured to measure temperature data; disturbed acoustic sensors (DAS) positioned in the subsurface or at the surface and configured to measure acoustic data; tiltmeters positioned in the subsurface or at the surface and configured to measure tilt data; thermal cameras positioned at the surface and configured to measure thermal data; methane sensors positioned at the surface and configured to measure methane data; global positioning sensors (GPS) positioned at the surface and configured to measure location data; and atmospheric sensors positioned at the surface and configured to measure atmospheric data. The operations also include measuring the seismic data using the one or more seismic sensors. The seismic data is measured before, during, and/or after a fluid is injected into an injection well in the subsurface. The fluid is carbon dioxide. The operations also include measuring the non-seismic data using the non-seismic sensors. The non-seismic data is measured before, during, and/or after the fluid is injected into the injection well in the subsurface. The operations also include synchronizing the seismic data and the non-seismic data to produce synchronized data. The operations also include mapping seismic hypocenters in the subsurface based on the synchronized data. The seismic hypocenters occur in the subsurface due to injection of the fluid into the injection well. Mapping the seismic hypocenters includes (1) interpreting the seismic hypocenters using trends and/or correlations and (2) determining the seismic hypocenters using triangulation. The seismic hypocenters include microseismic hypocenters. The operations also include displaying the mapped seismic hypocenters.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a seismograph with both P-wave and S-wave arrivals, according to an embodiment.

FIG. 2 illustrates a log showing S velocities (Vs) and P velocities (Vp), according to an embodiment.

FIG. 3 illustrates a log showing trace signal-to-noise ratios (SNRs), according to an embodiment.

FIG. 4 illustrates a station SNR map for Station 1, according to an embodiment.

FIG. 5 illustrates a station SNR map for Station 8, according to an embodiment.

FIG. 6 illustrates an array SNR, according to an embodiment.

FIG. 7 is a diagram illustrating a series of receivers located on surface, according to an embodiment.

FIG. 8A is a diagram illustrating configuration of a seismic sensor located on surface and coupled to a plurality of sensors of various types, according to an embodiment.

FIG. 8B is a diagram illustrating configuration of seismic sensors located on surface and downhole whilst coupled to a plurality of sensors of various types, according an embodiment.

FIG. 9 is a diagram illustrating an example of co-located displays showing seismic hypocenters in conjunction with various times series from the plurality of sensors, according to an embodiment.

FIG. 10 illustrates a flowchart of a method for monitoring seismic and microseismic activity in a subsurface, according to an embodiment.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers’ specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

### Induced Seismic Monitoring

Induced seismic monitoring focuses on detecting and analyzing seismic events triggered by human activities. These activities may include fluid injection or extraction, mining, geothermal energy production, and/or reservoir-induced seismicity. One objective is to understand the relationship between these activities and the resulting seismic events to mitigate risks and ensure safety.

In the oil and gas industry, hydraulic fracturing (i.e., fracking), carbon capture and storage (CCS), geothermal, and mining are common practices that can induce seismic events. By deploying a network of seismometers around the operation site, scientists can monitor induced seismicity in real-time. This data helps in adjusting operational parameters to minimize seismic risks and optimize production. Additionally, induced seismic monitoring is helpful in geothermal energy projects, where fluid injection into geothermal reservoirs can induce seismic events. Advanced techniques, such as the traffic light system (TLS), provide immediate feedback on injection operations, allowing for timely adjustments.

### Passive Seismic Monitoring

Passive seismic monitoring relies on natural seismic events, such as earthquakes and microseisms, to gather data about the Earth's subsurface. Unlike active seismic methods, which involve generating seismic waves, passive seismic monitoring continuously records ambient seismic noise and natural events over extended periods. This method is helpful for reservoir characterization and monitoring induced seismicity in exploration activities. By analyzing the spectral characteristics of recorded seismic signals, scientists can gain insights into subsurface stress regimes, fracture orientations, and rock properties.

This information is helpful for informed decision-making in resource exploration and management. Passive seismic monitoring is also used for environmental monitoring and hazard assessment. It can detect and analyze microseismic events associated with natural and anthropogenic activities, such as landslides, subsidence, and induced seismicity. This continuous monitoring approach offers unparalleled insights into temporal variations in subsurface conditions, facilitating early detection of potential hazards.

### Microseismic Monitoring

Microseismic monitoring is a specialized form of passive seismic monitoring that focuses on detecting and analyzing very small-scale seismic events (e.g., with magnitudes less than 2.0 on the Richter scale). These microseismic events are often induced by human activities, such as mining, hydraulic fracturing, enhanced oil recovery, geothermal operations, and underground gas storage.

Microseismic events, though too small to be felt on the surface, provide valuable information about the Earth's subsurface structure and the impact of human activities. By deploying sensitive seismic equipment, such as geophones and accelerometers, scientists can detect and record these events. The data collected helps in understanding subsurface stress distribution, fracture networks, and the effectiveness of industrial processes.

One of the applications of microseismic monitoring is in hydraulic fracturing, where it helps in mapping fracture propagation and optimizing fracturing operations. By analyzing the spatial and temporal distribution of microseismic events, operators can adjust their techniques to enhance hydrocarbon recovery and minimize environmental impacts. Additionally, microseismic monitoring is used in geothermal energy projects to monitor induced seismicity and ensure safe and efficient energy extraction.

Induced seismic monitoring, passive seismic monitoring, and microseismic monitoring are tools in modern geophysics. They provide valuable data for understanding and managing the Earth's subsurface activities, ensuring safety, optimizing resource extraction, and protecting the environment. As technology advances, these monitoring techniques may continue to evolve, offering even greater precision and insights into the dynamic processes beneath our feet, particularly if monitoring of ‘seismic’/’microseismic’ signals are integrated with real-time multi-physics-enabled sensors that may be used to analyze the occurrence of teleseisms in relation to a variety of measurements.

### Microseismic Processing Concepts

Microseismic events emit elastic waves whose frequencies fall mostly within the acoustic frequency range of 3 Hz to above 380 Hz. A hydraulic fracture induces an increase in the formation stress proportional to the net fracturing pressure as well as an increase in pore pressure due to fracturing fluid leak-off. Large tensile stresses are generated ahead of the crack’s tip; thus, generating large amounts of shear stress. Both combined mechanisms, pore pressure increase and formation stress increase, affect the stability of planes of weakness (e.g., natural fractures, natural joints, bedding planes, etc.) surrounding the hydraulic fracture. Therefore, these mechanisms cause the planes of weakness to undergo ‘shear slippage’. These events are analogous to small earthquake events along fault planes, hence the name microseismic events.

Microseismic events may be detected with multiple receivers (e.g., tri-axial geophones) deployed on a wireline array in an offset borehole (e.g., observation well). The wireline array may be an 8-level geophone array, transferring the data to the surface for subsequent processing so to yield a map of the tri-dimensional hydraulic fracture system’s geometry. Once the microseismic events are located, the actual fracture system may be interpreted within the envelope of the mapped events.

The concept of the microseismic event-location method is to recreate the travel path of the seismic energy back to its hypocenter. Three components may be calculated which fix the hypocenter in a tri-dimensional space: (a) distance, (b) depth and (c) back-azimuth angle. The third component, the back-azimuth angle, may be determined using hodogram analysis, which involves graphing the vector sums of the first motions of the three orthogonal geophones (e.g., one per Cartesian axis) joined together at each geophone station. P-waves oscillate in their direction of propagation; thus, the hodogram indicates an angle pointing back to the source in the direction of propagation.

Coalescence microseismic mapping (CMM) is a method of hypocenter determination which does not involve any human interaction during the microseismic monitoring. With the CMM algorithm, microseismic events can be detected, located, and displayed within seconds of their origin time. CMM is an industry innovation because, until recently, accurate location of the microseismic events that map a fracture involved manual picking of the P wave and S wave arrival times by a trained analyst. While the number of locatable events varies greatly for each treatment and formation, several thousand such microseisms are not uncommon for a single stage of treatment. Therefore, manual picking precludes real time location of more than a fraction of these events.

CMM uses signal to noise ratios (SNR’s) as measures of the signal quality at each stage of signal processing. For a vertical receiver array, there are five steps in the CMM method:
1) Calculate an anisotropic 2D lookup table of P-wave and S-wave travel times from a grid of possible source points to multiple stations.
2) Calculate a trace SNR vs. time function for each trace.
3) Calculate the product of the P-wave SNR and time-shifted S-wave SNR for each 3-component geophone station. The time shifts cover the range of possible S-P times. The resulting product can be called the Station SNR.
4) Stack the Station SNRs of the various stations using appropriate time shifts. These time shifts may be obtained from the lookup table of step 1. This stack can be called an Array SNR for the possible locations and origin times, that is, multiple solutions. The depth, distance and origin time with the maximum array SNR is considered the most likely solution.
5) The back azimuths to the source from each receiver are determined from the P-wave and S-wave polarizations. Tool orientations may be previously determined by calibration shot or gyroscope. Thus, the event may be located in cylindrical coordinates: distance, depth and azimuth. Each of these steps may be described in more detail in the following example.

### CMM example, single event

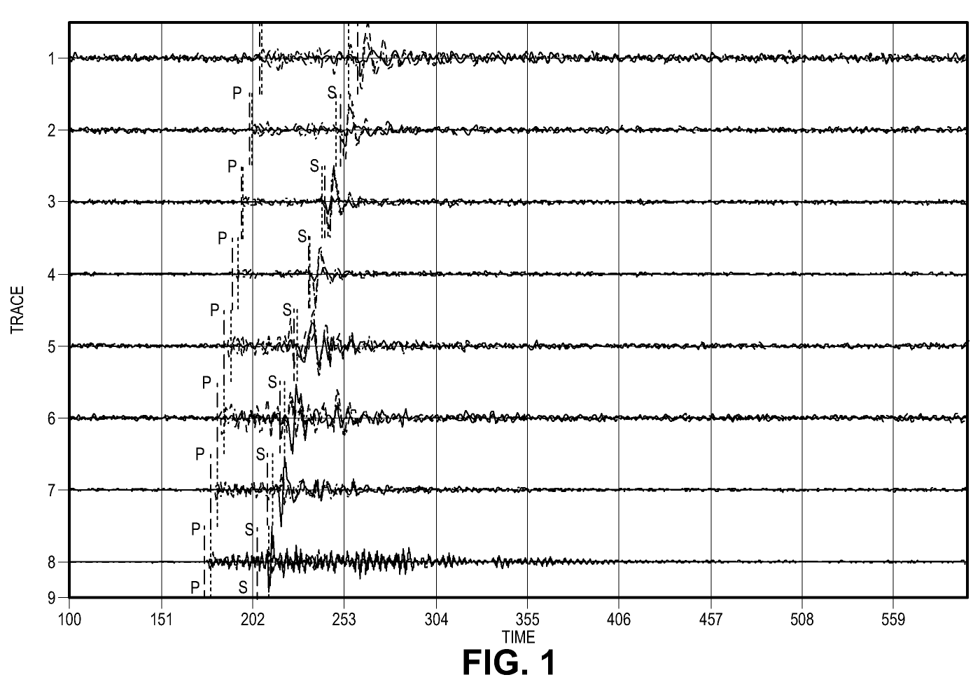

FIG. 1 illustrates an input to CMM (e.g., a seismograph). The 3-component output from eight stations, with 100 ft vertical spacing, is displayed with the shallowest station at the top. The x, y, and z traces from each station are overlaid.

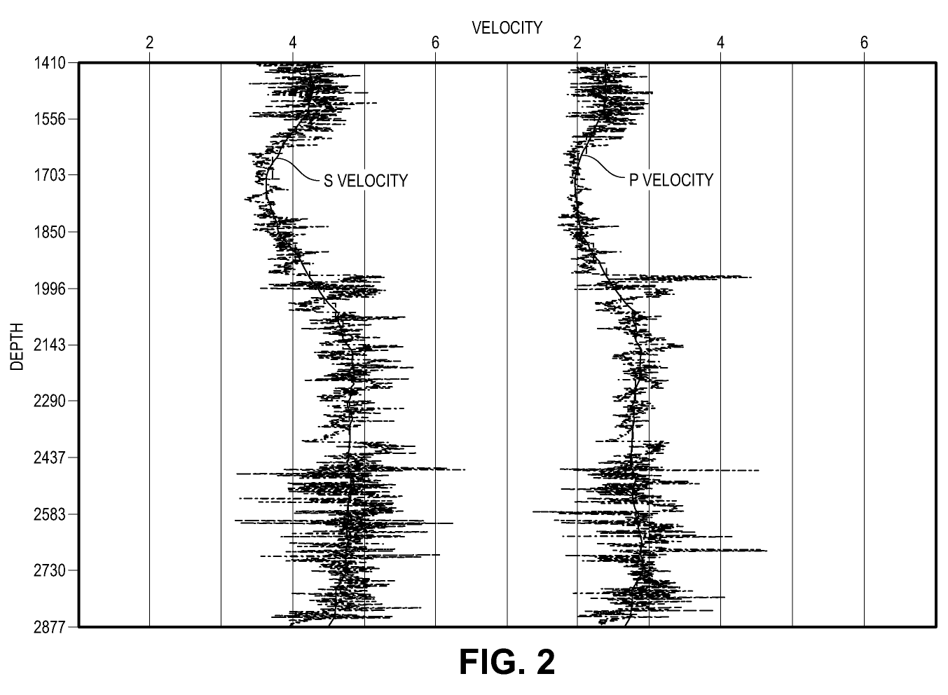

Step 1: Velocity modeling and lookup table. The initial 1-D model is a smoothed and blocked sonic log. FIG. 2 illustrates the raw sonic log, the 300 ft smoothed version, and the final blocked model. Anisotropy in horizontally layered media may generally cause horizontal velocities to be greater than vertical velocities. When perforation shots are available, they provide anisotropy calibration and station corrections. The smoothed and blocked sonic log, the anisotropy parameters, and station corrections may be input to a ray tracer. This ray tracer generates a lookup table of P and S wave travel times from a grid of possible source locations to each station.

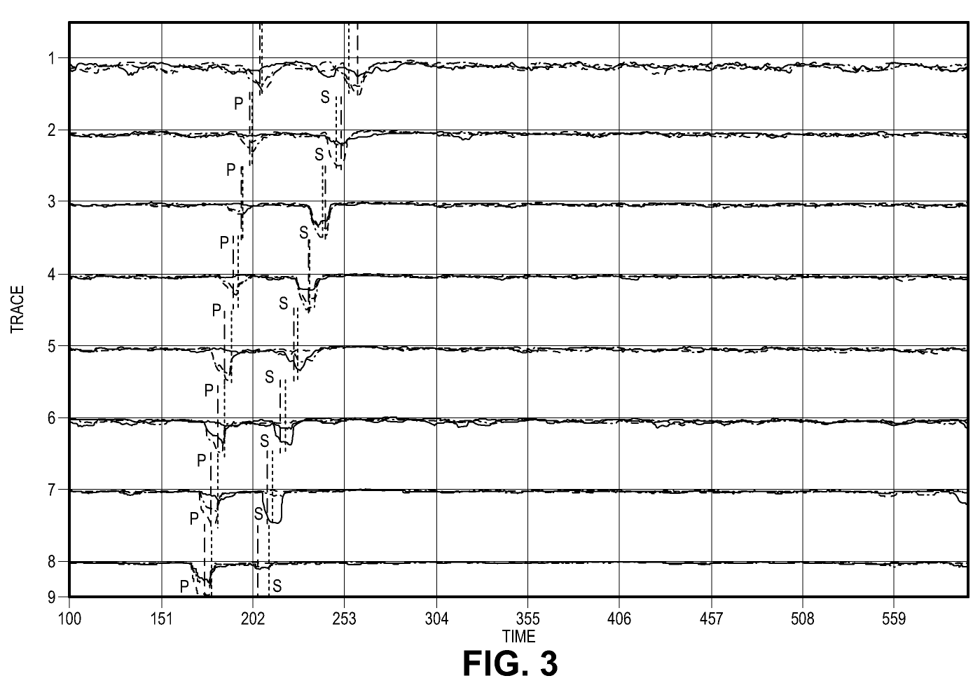

Step 2: Trace SNR. The average energy in a sliding short term window with length 8 ms represents the signal level. The average energy in a sliding long term window, with length 30 ms, represents the noise level. The ratio of these STA and LTA functions is the signal to noise ratio, or SNR, shown in FIG. 3. The STA and LTA functions may be indexed so that the SNR peak is at the onset of each arrival. At this point the data may be rotated so that the P wave SNR is on one component and the SH wave SNR is on another component. This rotation is illustrative.

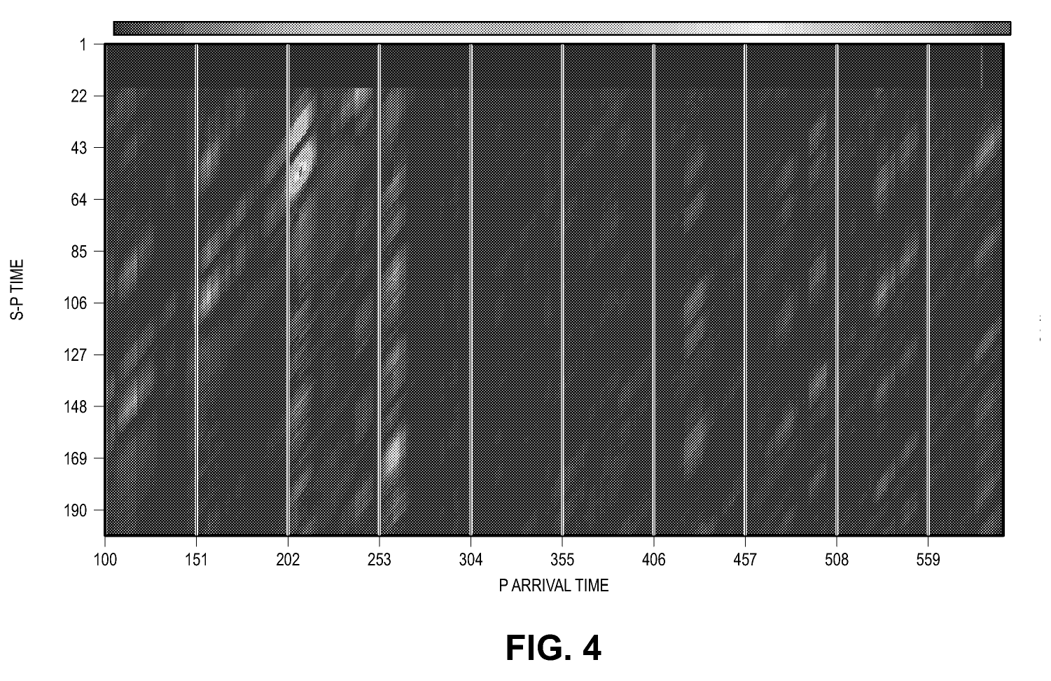

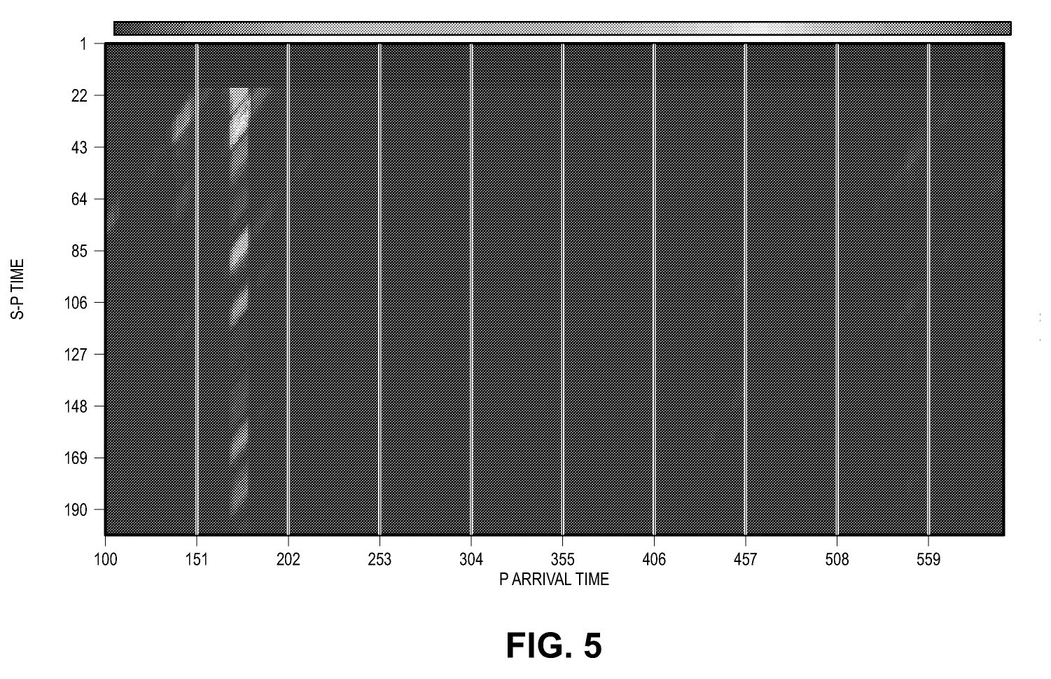

Step 3: Station SNR. The next step is finding the SNR for each station. The Station SNRs for stations 1 and 8 are plotted in FIGS. 4 and 5. The SH component trace SNR is shifted over a range of possible S-P times, 0-200 ms in this case, and multiplied by the P component SNR. A station SNR peak is apparent on station 1 with a P arrival time of 206 ms and S-P time of 56 ms. Station 8 has a similar peak at P time 175 ms and S-P time 29 ms. These are the same times we would expect from the times of the SNR peaks in FIG. 3.

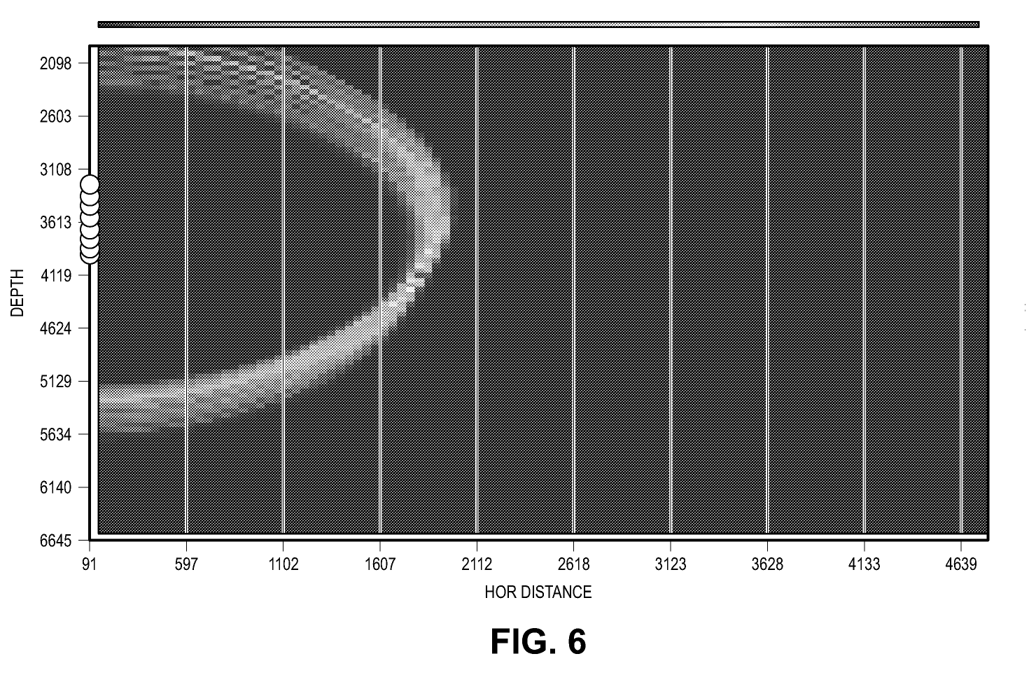

Step 4: Array SNR. To merge the information from the eight stations, the station SNR’s may be stacked using the lookup table of travel times from Step 1. Each time sample of the station SNR may be mapped or migrated to a point on the 2D location grid. This is analogous to migration of reflection seismic data to points in space to map the reflectors. In CMM, the station SNR time series is migrated to a distance-depth grid to map the sources. FIG. 6 shows the array SNR plotted on a grid of 100 depths and 100 horizontal distances. Each grid cell is 46 ft x 46 ft. This plot is for one particular origin time, 130 ms. Similar plots can be made for multiple possible origin times. The interpolated SNR maximum occurs at r = 1791 ft, z = 4211 ft. This is the 2D solution. Step 5 provides the 3rd dimension, azimuth.

Step 5: Azimuth. Multiple vibe shots distributed with good azimuthal coverage around the monitoring well provided a tool orientation reference. Since P and S onset times were automatically picked in Step 2, P and S particle motion azimuths may be determined for hodogram windows following each time pick. These windows were 8 ms for P and 12 ms for S. If ninety degrees is added to each S-wave azimuth, the circular average of the 16 azimuth estimates gives the back azimuth to the source.

### Exemplary Method 1

The present disclosure relates to a method that includes installing a plurality of receivers at a plurality of locations. The method may also include pairing one or more of the receivers with a plurality of sensors. The method may also include obtaining time series readings from the plurality of sensors and mapping seismic hypocenters based on the obtained time series. The method may also include displaying the mapped seismic hypocenters. The sensors may be or include carbon sensors, temperature sensors, seismic sensors, distributed acoustic sensing (DAS), geophones, accelerometers, or a combination thereof. The present disclosure introduces the idea to include any sensor as a measurement option and to display the measure as a time series in a platform jointly with the microseismic events.

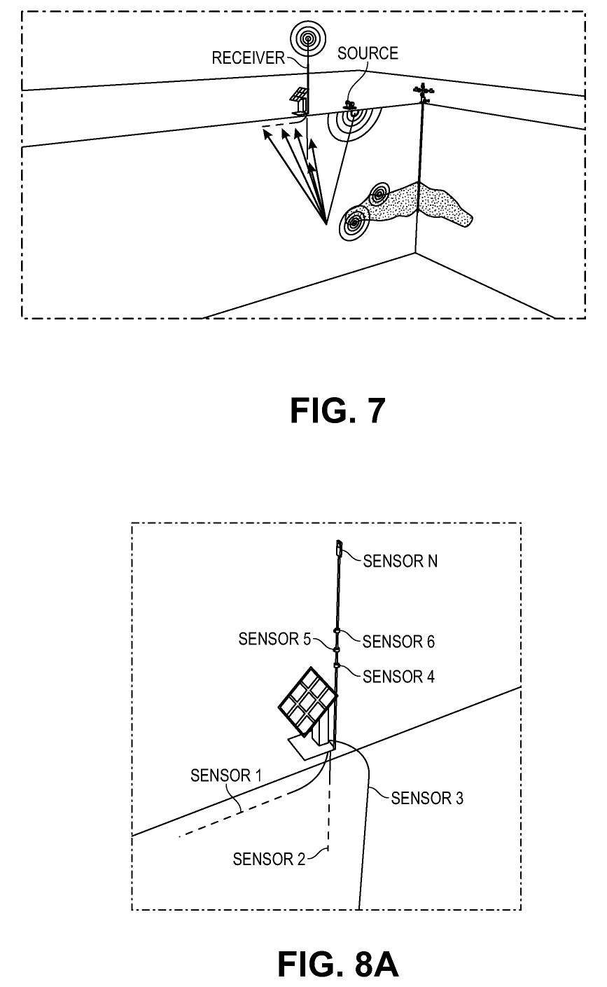

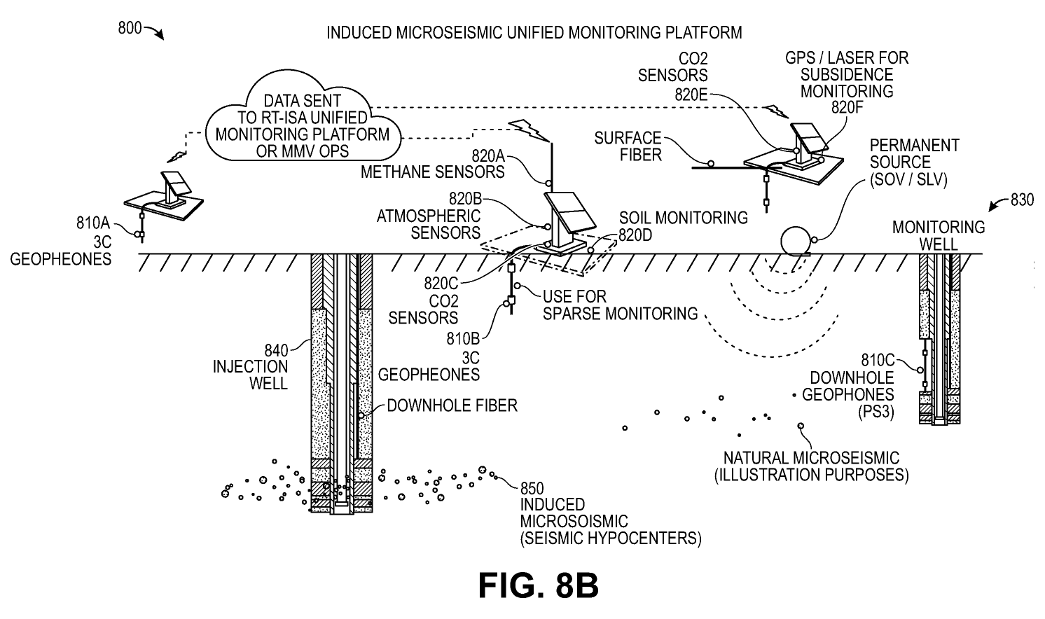

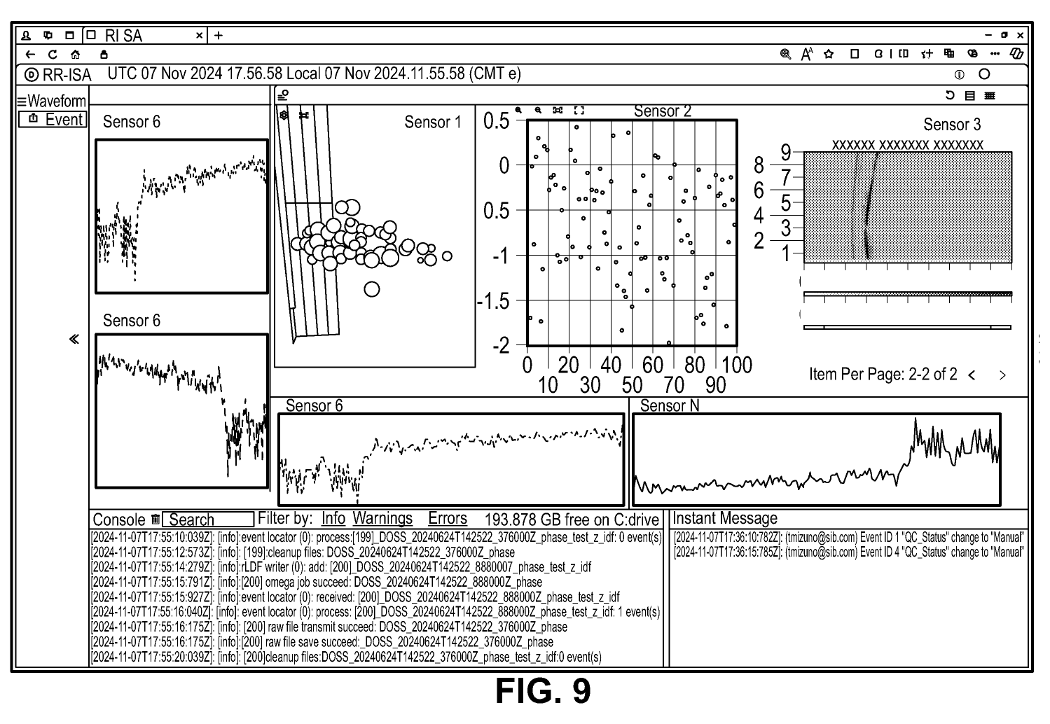

FIG. 7 illustrates a source 700 and a seismic sensor (e.g., receiver) 710, according to an embodiment. In a first step, a series of receivers (e.g., 1C and/or 3C) may be installed at a plurality of locations (RXm, RYm, RZm). Next, one or more of the receivers may be paired with a plurality of sensors of various types, t, such as, but not limited to, carbon sensor (t1), temperature sensor (t2), etc. Moreover, the sensors may also be or include seismic sensors which are located on the surface and coupled to other types of sensors of the plurality of sensors. The pairing is further illustrated in FIGS. 8A and 8B. Lastly, “seismic” hypocenters may be mapped in conjunction with various time series readings from the plurality of sensors of various types and displayed, as shown in FIG. 9, which displays readings from a sensor 1, which may include data from one or more receivers such as 1C and/or 3C, as well as a plurality of sensors such as distributed acoustic sensing (DAS), geophones, or accelerometers.

### Exemplary Method 2

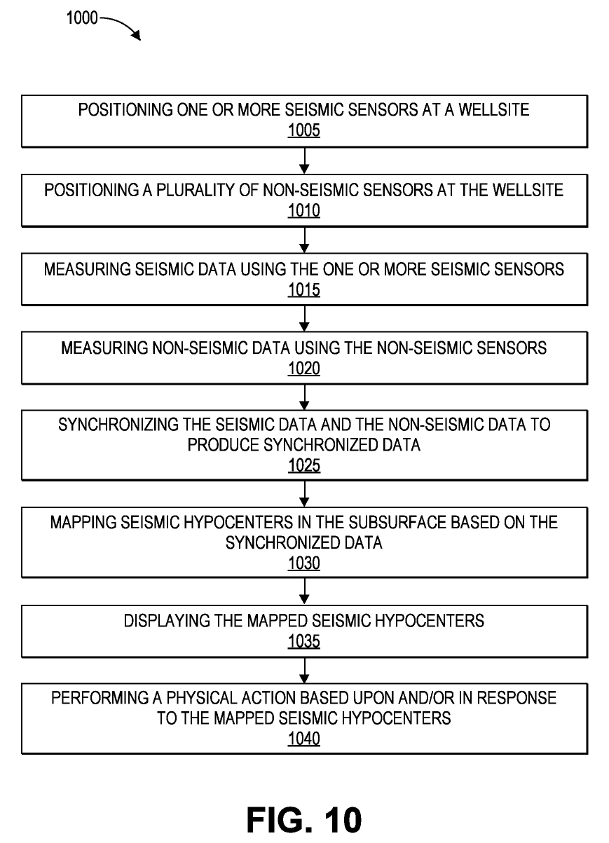

FIG. 10 illustrates a flowchart of a method 1000 for monitoring seismic and microseismic activity in a subsurface. An illustrative order of the method 1000 is provided below; however, one or more portions of the method 1000 may be performed in a different order, simultaneously, repeated, or omitted. At least a portion of the method 1000 may be performed using a computing system.

The method 1000 may include positioning one or more seismic sensors (also referred to as receivers) 810A-810C at a wellsite 800, as at 1005. The one or more seismic sensors 810A-810C may be positioned in the subsurface or at a surface above the subsurface. The one or more seismic sensors 810A-810C positioned in the subsurface may be positioned in a monitoring well 830. The one or more seismic sensors 810A-810C are configured to measure seismic data. The one or more seismic sensors 810A-810C may include one or more geophones (e.g., fiber optics), accelerometers, seismometers, or a combination thereof.

The method 1000 may also include positioning a plurality of non-seismic sensors 820A-820F at the wellsite 800, as at 1010. The non-seismic sensors 820A-820F may be configured to measure non-seismic data. The non-seismic sensors 820A-820F may include different types of non-seismic sensors. The different types of non-seismic sensors may include one or more carbon sensors positioned in the subsurface or at the surface and configured to measure carbon data. The different types of non-seismic sensors may also or instead include one or more temperature sensors positioned in the subsurface or at the surface and configured to measure temperature data. The different types of non-seismic sensors may also or instead include one or more disturbed acoustic sensors (DAS) positioned in the subsurface or at the surface and configured to measure acoustic data. The different types of non-seismic sensors may also or instead include one or more tiltmeters positioned in the subsurface or at the surface and configured to measure tilt data. The different types of non-seismic sensors may also or instead include one or more thermal cameras positioned at the surface and configured to measure thermal data. The different types of non-seismic sensors may also or instead include one or more methane sensors positioned at the surface and configured to measure methane data. The different types of non-seismic sensors may also or instead include one or more global positioning sensors (GPS) positioned at the surface and configured to measure location data. The different types of non-seismic sensors may also or instead include one or more atmospheric sensors positioned at the surface and configured to measure atmospheric data.

The method 1000 may also include measuring the seismic data using the one or more seismic sensors 810A-810C, as at 1015. The seismic data may be measured before, during, and/or after a fluid is injected into an injection well 840 in the subsurface. The fluid may be or include carbon dioxide, water, chemicals, etc.

The method 1000 may also include measuring the non-seismic data using the non-seismic sensors 820A-820F, as at 1020. The non-seismic data is measured before, during, and/or after the fluid is injected into the injection well 840 in the subsurface.

The method 1000 may also include synchronizing the seismic data and the non-seismic data to produce synchronized data, as at 1025.

The method 1000 may also include mapping seismic hypocenters 850 in the subsurface based on the synchronized data, as at 1030. Examples of mapping the seismic hypocenters are described above. The seismic hypocenters 850 may occur in the subsurface due to injection of the fluid into the injection well 840. The seismic hypocenters 850 may be mapped by trends, correlation, and/or triangulation. The seismic hypocenters 850 may include microseismic hypocenters and/or seismic events. In an example, if seismic activity increases when more fluid is injected, then reducing the injection volume may help reduce event activity. In another example, if magnitudes observed increase with the type of fluid injected, then changing the chemical composition may help reduce event activity.

The method 1000 may also include displaying the mapped seismic hypocenters 850, as at 1035.

The method 1000 may also include performing an action based upon and/or in response to the mapped seismic hypocenters 850, as at 1040. The action may be or include generating and/or transmitting a signal that recommends, instructs, or causes a physical action to occur. The action may also or instead include performing the physical action. In an example, the physical action may include changing injections parameters for the injection well 840. The injection parameters may include a flow rate of the fluid, a pressure of the fluid, and/or a composition of fluid.

Examples in the present disclosure may also be directed to a non-transitory computer-readable medium storing computer-executable instructions and executable by one or more processors of the computer via which the computer-readable medium is accessed. A computer-readable media may be any available media that may be accessed by a computer. By way of example, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A method for monitoring seismic and microseismic activity in a subsurface, the method comprising:
positioning one or more seismic sensors at a wellsite;
positioning a plurality of non-seismic sensors at the wellsite;
measuring seismic data using the one or more seismic sensors;
measuring non-seismic data using the non-seismic sensors;
synchronizing the seismic data and the non-seismic data to produce synchronized data; and
mapping seismic hypocenters in the subsurface based on the synchronized data.

2. The method of claim 1, wherein the one or more seismic sensors are positioned in the subsurface or at a surface above a subsurface.

3. The method of claim 1, wherein the one or more seismic sensors comprise one or more geophones, fiber optics, accelerometers, seismometers, or a combination thereof.

4. The method of claim 1, wherein the non-seismic sensors comprise different types of non-seismic sensors.

5. The method of claim 1, wherein mapping the seismic hypocenters comprises (1) interpreting the seismic hypocenters using trends and/or correlations and/or (2) determining the seismic hypocenters using triangulation.

6. The method of claim 1, wherein the seismic hypocenters comprise microseismic hypocenters and seismic events.

7. The method of claim 1, wherein the seismic data and the non-seismic data are measured before, during, and/or after a fluid is injected into an injection well in the subsurface, and wherein the seismic hypocenters occur in the subsurface in relation to injection of the fluid into the injection well.

8. The method of claim 7, wherein the fluid comprises carbon dioxide.

9. The method of claim 1, further comprising displaying the mapped seismic hypocenters.

10. The method of claim 1, further comprising changing injection parameters for an injection well in response to and/or based upon the mapped seismic hypocenters.

11. A computing system, comprising:
one or more processors; and
a memory system comprising one or more non-transitory computer-readable media storing instructions that, when executed by at least one of the one or more processors, cause the computing system to perform operations, the operations comprising:
positioning one or more seismic sensors at a wellsite, wherein the one or more seismic sensors are positioned in the subsurface or at a surface above a subsurface, wherein the one or more seismic sensors are configured to measure seismic data, and wherein the one or more seismic sensors comprise one or more geophones, accelerometers, seismometers, or a combination thereof;
positioning a plurality of non-seismic sensors at the wellsite, wherein the non-seismic sensors are configured to measure non-seismic data, and wherein the non-seismic sensors comprise different types of non-seismic sensors;
measuring the seismic data using the one or more seismic sensors;
measuring the non-seismic data using the non-seismic sensors;
synchronizing the seismic data and the non-seismic data to produce synchronized data;
mapping seismic hypocenters in the subsurface based on the synchronized data, wherein mapping the seismic hypocenters comprises (1) interpreting the seismic hypocenters using trends and/or correlations and/or (2) determining the seismic hypocenters using triangulation, and wherein the seismic hypocenters comprise microseismic hypocenters; and
displaying the mapped seismic hypocenters.

12. The computing system of claim 11, wherein the different types of non-seismic sensors comprise one or more:
carbon sensors positioned in the subsurface or at the surface and configured to measure carbon data;
temperature sensors positioned in the subsurface or at the surface and configured to measure temperature data;
disturbed acoustic sensors (DAS) positioned in the subsurface or at the surface and configured to measure acoustic data;
tiltmeters positioned in the subsurface or at the surface and configured to measure tilt data;
thermal cameras positioned at the surface and configured to measure thermal data;
methane sensors positioned at the surface and configured to measure methane data;
global positioning sensors (GPS) positioned at the surface and configured to measure location data;
atmospheric sensors positioned at the surface and configured to measure atmospheric data; or
a combination thereof.

13. The computing system of claim 11, wherein at least one of the one or more seismic sensors positioned in the subsurface is positioned in a monitoring well.

14. The computing system of claim 11, wherein the seismic data and the non-seismic data are measured before, during, and/or after a fluid is injected into an injection well in the subsurface, and wherein the seismic hypocenters occur in the subsurface due to injection of the fluid into the injection well.

15. The computing system of claim 14, wherein the fluid comprises carbon dioxide.

16. A non-transitory computer-readable medium storing instructions that, when executed by one or more processors of a computing system, cause the computing system to perform operations, the operations comprising:
positioning one or more seismic sensors at a wellsite, wherein the one or more seismic sensors are positioned in the subsurface or at a surface above a subsurface, wherein at least one of the one or more seismic sensors positioned in the subsurface is positioned in a monitoring well, wherein the one or more seismic sensors are configured to measure seismic data, and wherein the one or more seismic sensors comprise geophones, accelerometers, and seismometers;
positioning a plurality of non-seismic sensors at the wellsite, wherein the non-seismic sensors are configured to measure non-seismic data, wherein the non-seismic sensors comprise different types of non-seismic sensors, and wherein the different types of non-seismic sensors comprise one or more:
carbon sensors positioned in the subsurface or at the surface and configured to measure carbon data;
temperature sensors positioned in the subsurface or at the surface and configured to measure temperature data;
disturbed acoustic sensors (DAS) positioned in the subsurface or at the surface and configured to measure acoustic data;
tiltmeters positioned in the subsurface or at the surface and configured to measure tilt data;
thermal cameras positioned at the surface and configured to measure thermal data;
methane sensors positioned at the surface and configured to measure methane data;
global positioning sensors (GPS) positioned at the surface and configured to measure location data; and
atmospheric sensors positioned at the surface and configured to measure atmospheric data;
measuring the seismic data using the one or more seismic sensors, wherein the seismic data is measured before, during, and/or after a fluid is injected into an injection well in the subsurface, and wherein the fluid comprises carbon dioxide;
measuring the non-seismic data using the non-seismic sensors, wherein the non-seismic data is measured before, during, and after the fluid is injected into the injection well in the subsurface;
synchronizing the seismic data and the non-seismic data to produce synchronized data;
mapping seismic hypocenters in the subsurface based on the synchronized data, wherein the seismic hypocenters occur in the subsurface due to injection of the fluid into the injection well, wherein mapping the seismic hypocenters comprises (1) interpreting the seismic hypocenters using trends and/or correlations and (2) determining the seismic hypocenters using triangulation, and wherein the seismic hypocenters comprise microseismic hypocenters; and
displaying the mapped seismic hypocenters.

17. The non-transitory computer-readable medium of claim 16, wherein the operations further comprise performing an action based upon and/or in response to the mapped seismic hypocenters.

18. The non-transitory computer-readable medium of claim 17, wherein the action comprises generating and/or transmitting a signal that recommends, instructs, or causes a physical action to occur.

19. The non-transitory computer-readable medium of claim 18, wherein the physical action comprises changing injections parameters for the injection well.

20. The non-transitory computer-readable medium of claim 19, wherein the injection parameters comprise a flow rate of the fluid, a pressure of the fluid, and/or a composition of fluid.
